(19) United States
(12) Patent Application Publication
(10) Pub. No.: US 2009/0008298 A1
(43) Pub. Date: Jan. 8, 2009

(54) Systems and Methods for Processing Municipal Solid Waste

(76) Inventor: Michael Studley, Orlando, FL (US)

Correspondence Address: SMITH FROHWEIN TEMPEL GREENLEE BLAHA, LLC, Two Ravinia Drive, Suite 700, ATLANTA, GA, 30346, US

(21) Appl. No.: 11/773,370

(22) Filed: Jul. 3, 2007

(51) Int. Cl. B03B 9/06; B01J 7/00; B07B 13/04; B07C 5/16; B08B 7/00; G06F 17/00; H02K 57/00

(52) U.S. Cl. 209/2; 15/1; 209/645; 209/659; 310/10; 48/61; 705/500

(57) ABSTRACT

A pre-sorter forwards items from solid waste to designated processing paths in response to their size. Large items are manually processed to remove non-recyclables, to fuel a generator, to be returned to the pre-sorter after removal from a container, or forwarded to processing streams. The smallest items are forwarded to a first chain of machines that remove metal and glass from the items. Intermediate sized items are forwarded to an assembly that separates small, relatively dense, items from larger lightweight items. The former items are mixed and processed by a first chain of machines. The latter items are forwarded to a second chain of machines that separate and remove paper and other containers from recyclable metal and plastic. Multiple paper types are identified and removed by a third chain of machines. A remediator receives residual items from each of the first, second and third chains of machines.

### BACKGROUND

1. Technical Field

The present systems and methods relate generally to the processing of municipal solid waste, and more particularly recycling, remediating, and converting municipal solid waste.

2. Description of Related Art

Municipal solid waste (MSW) includes residential garbage among other items. MSW includes organic and inorganic items. Organic items, such as paper, plastic, wood, cloth, leather, food waste and yard waste contain carbon. Inorganic items, such as metal, glass, ceramics, etc., do not contain carbon.

A U.S. Environmental Protection Agency (EPA) study published in 2005 indicated that MSW was disposed of by recycling, incinerating or placing the MSW in a landfill. Nearly a third of the MSW generated in the U.S. is recycled. Recycling methods include home sorting with periodic pick-up and transportation to collection centers or to one or more material recyclers as well as central or municipal collecting and sorting at material recycling facilities (MRFs).

In commingled recycling, homeowners generally sort their recyclable items (e.g., paper, glass, plastic) into different colored plastic bins. The sorted items are then picked up by municipal employees or private contractors using trucks fitted with multiple storage cells. The trucks are driven to material collection facilities or to one or more material recyclers. The pre-sorted materials often must be further sorted, often by hand, to separate colored paper, newspaper and cardboard from other paper; colored glass from clear glass; and containers by type of materials (i.e. high-density polyethylene (HDPE), natural and pigmented, and polyethylene terephthalate (PET) from other plastics). Home sorting and pick-up solutions are expensive as they require specialized trucks, fuel, and drivers in addition to conventional single stream garbage pick-up and transport.

In single stream recycling, all recyclables are sorted into a single container by the homeowner. The container is picked up and processed in a MRF. The MRFs typically have a large area where front end loaders are used to extract large or dangerous items such as mattresses or propane tanks from the MSW. The MRFs often have a shredder at the front of the recycling process. The shredder reduces the MSW such that items from the MSW are easier for manual sorters to handle. Recyclable items are normally identified and removed from the reduced waste stream via manual methods. In addition to manual methods, ferrous metal separators, hysteresis/eddy current separators, trommels and disc separators are used to remove items from the waste stream. Removed items are placed in chutes that direct the items into bins or trailers that can be pulled by a truck to a buyer of recycled material. Remaining MSW is reloaded into a truck and transported to a landfill or to an incinerator.

MRFs are difficult to manage. The work is undesirable and generally attracts employees that are typically unreliable and that require close supervision. Consequently, MRFs suffer from significant employee turnover. Nearly all MRFs operate over a single shift.

In addition to the difficulties introduced because of the nature of the work, a number of other problems affect MRFs that use shredders to prepare a waste stream for manual sorting. The shredder at the front of the MRF process tears up many of the plastic containers making them unsuitable for recycling, breaks an inordinate number of the glass bottles making it more difficult to recycle the glass and contaminates the various paper products with glass shards. Sophisticated electronic solutions with sensors have been largely ignored as these solutions are too expensive for operation over a single shift each work day.

Approximately 15% of solid waste produced in the U.S. is incinerated. Incinerators of conventional design burn refuse on moving grates in refractory-lined chambers. Combustion is eighty-five to ninety percent complete for the combustible materials. In addition to heat, the products of incineration include carbon monoxide, carbon dioxide, as well as oxides of sulfur, nitrogen and other gaseous pollutants. The nongaseous products are fly ash and unburned solid residue. Emissions of fly ash and other particles are often controlled by wet and dry scrubbers, electrostatic precipitators, and filters positioned inside or adjacent the exhaust stacks. Collected fly ash and unburned solid residue is generally transported to a landfill. About 25% of incinerator input tonnage is unburned solid residue that must be subsequently disposed of in a land fill.

The introduction of plastics and products with heavy metals such as batteries into an incinerator produces undesirable furans, dioxins and releases lead, mercury, cadmium and other heavy metals into the air. As a result, many cities and states have outlawed incinerators because of the undesirable airborne emissions they release into the local environment.

Over half of all solid waste disposed in the U.S. is placed in “landfills.” A landfill is a carefully designed structure built into or on top of the ground in which solid waste is isolated from the surrounding environment (i.e., groundwater, air, rain and runoff). This isolation is accomplished with a bottom liner and daily covering of soil. Landfills use a clay or synthetic (i.e., plastic) “liner” to isolate the solid waste from the environment.

The purpose of a landfill is to bury the MSW in such a way that it will be isolated from groundwater, will be kept dry and will not be in contact with air. Under these conditions, solid waste will decompose very slowly if at all. A landfill is not like a compost pile, where the goal is to induce decomposition of the organic material in the pile.

In modern landfills, the solid waste is spread in thin layers, each of which is compacted by heavy industrial equipment before the next layer is spread. When about ten feet of refuse has been deposited, it is covered by a thin layer of clean earth, which is also compacted. Pollution of surface and groundwater is minimized by lining and contouring the fill, compacting and planting a ground cover, selecting proper soil, diverting upland drainage from encountering the landfill, and locating landfills at sites not subject to flooding or high groundwater levels. Despite efforts to minimize the contamination of ground water, landfills leak and are known to generate flammable gases, mostly methane, through the anaerobic decomposition of the organic solid waste. Methane is generally thought to be more than 20 times worse as a greenhouse gas than carbon dioxide. Thus, most landfills will try to capture the escaping methane gas and either flare the gas on-site or, in a lesser number of cases due to the caustic nature of the gas, collect and combust the escaping gas to generate electricity. It is generally thought that less than 90% of the escaping methane is captured. Therefore, landfills are several times worse than an incinerator as a contributor to greenhouse gases.

Despite the development of techniques to minimize adverse environmental effects from solid waste disposal and management, further improvements are desired, especially in the development of systems and methods that provide an economic incentive to make advantageous use of solid waste.

### SUMMARY

An embodiment of a system that processes MSW includes a collection pit, pre-sorter, protection station, corrugated cardboard processor, an assembly, as well as first, second and third chains of automated machines.

An alternative embodiment of a system that processes MSW includes a collection pit, pre-sorter, protection station, corrugated cardboard processor, an assembly, the first, second and third chains of automated machines and a remediator.

In these systems, the collection pit is coupled to the pre-sorter, which separates and forwards the MSW via multiple outputs in accordance with the size of the item. The protection station receives the MSW from a first pre-sorter output, which forwards items having a dimension larger than a first predetermined dimension. The corrugated cardboard processor is coupled to an output of the protection station. The corrugated cardboard processor removes recyclable corrugated cardboard from the MSW. The assembly receives MSW from a second pre-sorter output, which forwards items having a dimension smaller than the first predetermined dimension and larger than a second predetermined dimension. The first chain of automated machines receives MSW from a third pre-sorter output, which forwards items having a dimension smaller than the second predetermined dimension. The first chain of automated machines removes items consisting of metals and glass from the MSW for recycling. The second chain of automated machines receives MSW from the protection station and the assembly. The second chain of automated machines removes items consisting of paper, metal and plastic from the MSW. The third chain of automated machines receives non-bulk recyclable corrugated cardboard from the corrugated cardboard processor and paper items from the second chain of automated machines. The third chain of automated machines separates and removes multiple paper types for recycling. The remediator receives unrecycled MSW from each of the first, second and third chains of automated machines. The remediator converts the unrecycled MSW into one or more fuels.

In alternative embodiments, fuels produced by the remediator are used to produce steam. The produced steam can be sold or used to drive a generator to produce electricity. In still other embodiments, fuels produced by the remediator are used to drive a generator to produce electricity.

An embodiment of a method for processing solid waste includes the steps of: receiving MSW, the MSW including organic, inorganic, recyclables and non-recyclables, transferring the MSW into a collection pit, conveying the MSW from the collection pit to a recycling system, using automated means in the recycling system for removing one or more recyclables and using unrecycled organic material from the recycling system to fuel a power system.

The figures and detailed description that follow are not exhaustive. The disclosed embodiments are illustrated and described to enable one of ordinary skill to make and use the systems and methods for processing solid waste. Other embodiments, features and advantages will be or will become apparent to those skilled in the art upon examination of the following figures and detailed description. All such additional embodiments, features and advantages are within the scope of the systems and methods as defined in the accompanying claims.

### BRIEF DESCRIPTION OF THE FIGURES

The systems and methods for processing solid waste can be better understood with reference to the following figures. The components within the figures are not necessarily to scale, emphasis instead being placed upon clearly illustrating the principles of operation. Moreover, in the figures, like reference numerals designate corresponding parts throughout the different views.

FIG. 1 is a block diagram illustrating an embodiment of a system for processing municipal solid waste.

FIG. 2 is a schematic diagram illustrating an embodiment of the recycling system of FIG. 1.

FIGS. 3A-3C are schematic diagrams illustrating embodiments of the first, second and third chains of automated machines of FIG. 2.

FIG. 4 is a flow diagram illustrating an embodiment of a method for processing municipal solid waste.

FIG. 5 is a flow diagram illustrating an alternative embodiment of a method for processing municipal solid waste.

FIG. 6 is a flow diagram illustrating another alternative embodiment of a method for processing municipal solid waste.

FIG. 7 is a flow diagram illustrating a fourth alternative embodiment of a method for processing municipal solid waste.

FIGS. 8A-8D are flow diagrams illustrating a fifth alternative embodiment of a method for processing municipal solid waste.

### DETAILED DESCRIPTION

The summarized systems and methods are an extension of a growing trend associated with the treatment and handling of solid waste material commonly referred to as “resource recovery.” Resource recovery is intended to recover useful materials from raw municipal solid waste (MSW). To the extent that MSW is recycled/recovered, emissions will be diminished.

The present systems and methods include a new integrated MSW disposal process and reflect a paradigm that uses sophisticated automated equipment with minimal manpower to recycle materials commonly found in municipal solid waste including a significant amount of the fiber (paper), plastic, metals and glass. The organic remainder, and in some embodiments, non-recyclable items in the solid waste will be moved to a linked power generation system that will convert these items to electricity.

The present systems and methods can be used to promote the generation of a steady stream of remediated fuels to operate continuously one or more boilers used in a steam-based generator. Manual processing and intervention are moved to a preliminary stage in the process and need not be continuous to produce enough remediated fuel to operate a generator around the clock.

The present systems and methods focus on maintaining the integrity of recyclable materials rather than on making things easier for hand recycling as is the case with conventional MRFs. The present systems and methods sort and remove recyclables and handle these items to retain their integrity for recycle markets. In addition, the following items can be separated and recycled from the solid waste. Fiber including corrugated paper, newspaper, office or white paper, and mixed paper can be separated and stored for recyclers of these items. Paper that is not recycled is shredded, dried and forwarded to a remediator that together with a power generation system converts the paper to steam. The steam can be harnessed to generate electricity. The remediator enhances the process but the process can operate without the remediator and still realize a significant improvement over incinerators. Plastic, including items made from polyethylene terephthalate (PET), natural and pigmented HDPEs, as well as the plastics marked with recycle designators 3 through 7, can be separated and stored for recycle markets. Unrecycled plastics are shredded, the surfaces are dried and the pieces are forwarded to the remediator. Metals, including ferrous metals such as iron and steel, and non-ferrous metals such as aluminum, copper, zinc, chromium, among others, can also be identified and removed from the solid waste for recycling. Glass containers as well as broken pieces of glass are identified by color, separated from ceramics, cleaned and removed for recycling.

Other organic components within the MSW are not recycled including food waste, yard waste, textiles, leather and rubber. These unrecycled organic materials are converted into steam and perhaps electricity via the remediator and the power generation system. Inorganic material separated from the organic material in the recycling system can be used in the manufacture of concrete products such as light pavers and building blocks.

By recycling plastics, batteries and other sources of heavy metal and by separating and capturing other heavy metals including mercury in the remediator, the present systems and methods present a significant improvement over conventional incinerators and landfills that pollute the environment. To the extent that plastics are recycled, furan and dioxin emissions will be diminished. To the extent that lead and cadmium batteries are recycled, the heavy metal complex gases generated when these items are incinerated will be diminished. To the extent that MSW is recycled, these and other emissions that result from combustion, such as CO, CO₂ and NO_{X} will also be diminished. In addition to these improvements, the recycling of papers, plastic, glass and metals all will contribute to lowered costs and environmental benefits in the production of new paper, plastics, glass and metals.

One embodiment of a system that processes MSW includes a collection pit and a recycling system. An alternative embodiment includes a collection pit, recycling system and an unrecycled solid waste remediator. Another embodiment of a system includes a collection pit, recycling system, unrecycled solid waste remediator, and a power generation system. In these embodiments, the collection pit receives and holds solid waste. Trucks may deliver the MSW to the collection pit during an 8 to 12 hour period each work day.

The recycling system separates and holds recyclable items and forwards unrecycled solid waste to the unrecycled solid waste remediator. Fuel generated by converting the unrecycled solid waste from the recycling system as well as organic waste that bypasses the recycling system is sufficient to drive a power generation system continuously. The recycling system includes a collection pit, pre-sorter, protection station, corrugated cardboard processor, an assembly, as well as first, second and third chains of automated machines. The pre-sorter receives a stream of MSW from the collection pit and distributes the MSW via multiple outputs based on the size of an item. The pre-sorter outputs are connected to the protection station and the first, second and third chains of automated machines. Each of the chains includes specialized sorting equipment, usually automatically controlled. The protection station, manned by an operator, protects the corrugated cardboard processor from large or potentially dangerous MSW. That is, the operator prevents relatively large non-corrugated cardboard items from entering the corrugated cardboard processor. In addition, the operator at the protection station is there to remove items in the MSW that may have escaped detection and removal by the operator in the collection pit. A first train of automated machines receives relatively smaller items in the MSW from a corresponding pre-sorter output. The first train of automated machines removes recyclable items consisting of metal and glass from the solid waste. A second train of automated machines receives and processes intermediate sized MSW from a second pre-sorter output and an output of the protection station. The second train is then further divided into subtrains that separate and remove recyclable items consisting of metal and plastic from the MSW. The third train of automated machines receives MSW from a second output of the corrugated cardboard processor and items consisting of paper from the second train of automated machines. The third train separates and removes newspaper, mixed paper and white paper from the MSW for recycling.

A unrecycled solid waste remediator receives solid waste from one or more trucks, the collection pit, protection station and each of the first, second and third chains of automated machines. The unrecycled solid waste remediator converts the unrecycled organic MSW into one or more fuels that can be used to drive a generator to produce electrical energy.

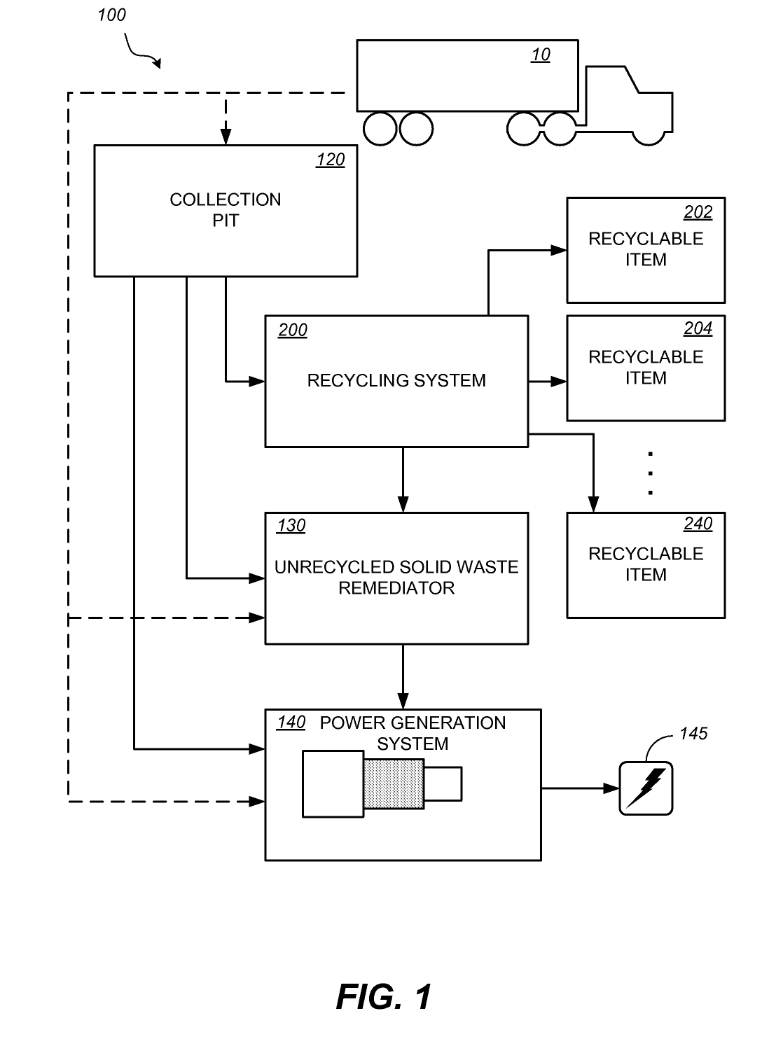

Having generally described some embodiments of systems for processing MSW, attention is now directed to the non-limiting examples shown in the illustrated embodiments in FIGS. 1-8.

FIG. 1 is a block diagram illustrating an embodiment of a system 100 for processing municipal solid waste. System 100 includes a collection pit 120, recycling system 200, residual solid waste remediator 130 and power generation system 140. As shown in FIG. 1, collection pit 120 receives municipal solid waste indicated by a dashed line from one or more conventional waste collection trucks 10. Although only a single waste collection truck 10 is shown, preferably collection pit 120 is arranged to receive municipal solid waste from additional trucks via additional unloading docks or ports. Additional dashed lines indicate that organic items not intended for recycling can bypass collection pit 120. For example, organic items that can be remediated, such as yard waste, food waste, scrap lumber, are forwarded to a shredder (not shown) before being converted by unrecycled solid waste remediator 130. In addition, where local and federal regulations permit, unrecycled organic matter can bypass recycling system 200 and unrecycled solid waste remediator 130 and be consumed directly to generate electricity by power generation system 140. Organic waste that can be consumed directly in the generation of electric power may include used cooking oil, sewage sludge, etc. When truck 10 includes a load of organic waste that is not designated for recycling, truck 10 bypasses recycling system 200 and dumps its load in the vicinity of a shredder/drier (not shown) that processes waste designated for unrecycled solid waste remediator 130. When truck 10 includes a load of organic waste that can be directly consumed, truck 10 may alternatively, bypass the recycling system 200 and the unrecycled solid waste remediator 130 and dump its load in proximity to a burner associated with power generation system 140. It should be understood that solid waste may be moved to and from various elements in system 100 including recycling system 200, unrecycled solid waste remediator 130 and power generation system 140 via one or more mechanisms. These mechanisms may include vehicles, chutes, elevators, conveyors, rollers, escalators and the like. For simplicity of illustration and discussion, these and other mechanisms for transporting a stream of MSW or items therein will be shown with a directional arrow and designated as a path.

As further indicated in FIG. 1, received solid waste is forwarded in a controlled manner to recycling system 200. Recycling system 200 identifies, sorts and removes a number of different types of various recyclable items. In the illustrated embodiment, recycling system 200 removes and temporarily stores recyclable item 202, recyclable item 204 through to recyclable item 240. It should be understood that recycling system 200 may identify and remove more or less recyclable items. Non-recyclable items and other residual solid waste is forwarded to unrecycled solid waste remediator 130 from recycling system 200. Alternatively, solid waste stored in collection pit 120 may bypass recycling system 200 and be transported directly to the unrecycled solid waste remediator 130.

The unrecycled solid waste remediator 130, unlike conventional incinerators and landfills, converts the remaining and/or bypassed solid waste into one or more fuels that can be used to supply power generation system 140, which in turn generates electricity 145 for resale to offset operating costs associated with the recycling system 200.

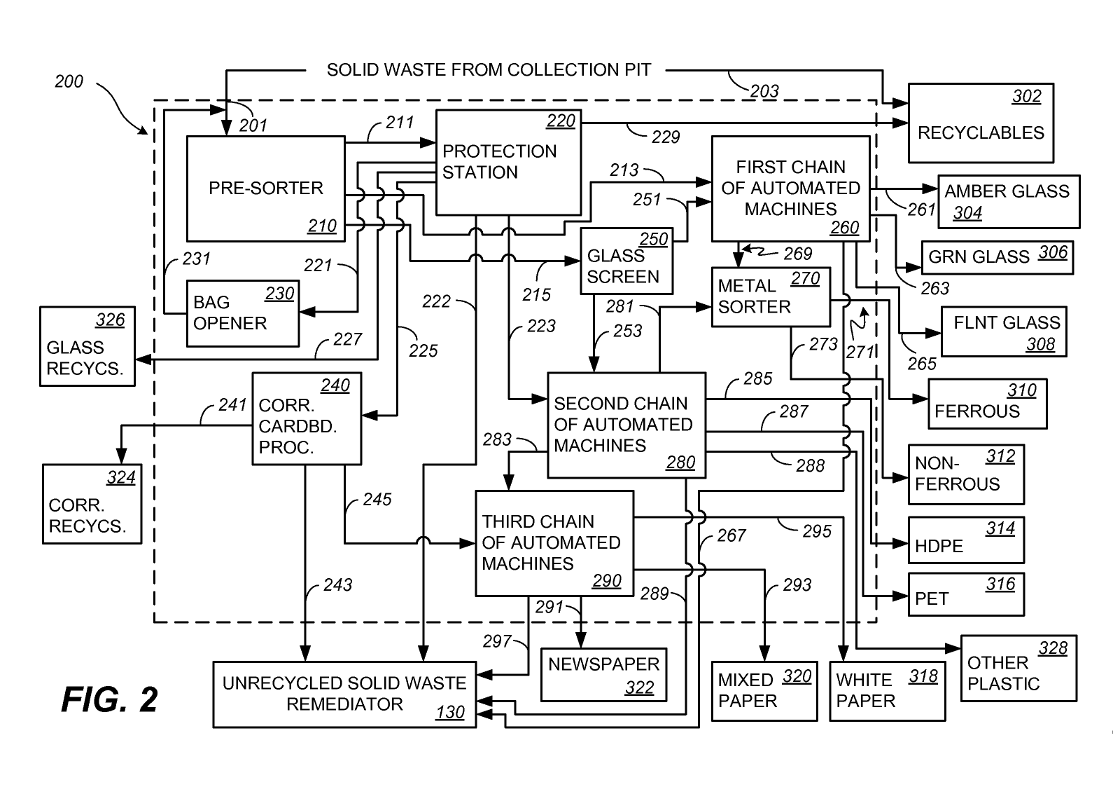

FIG. 2 is a schematic diagram illustrating an embodiment of the recycling system 200 of FIG. 1. As illustrated in FIG. 2, recycling system 200 receives solid waste from collection pit 120 (FIG. 1) via path 201 and separates multiple types of recyclable items before forwarding non-recyclable and other residual waste to unrecycled solid waste remediator 130. In the illustrated embodiment, recycling system 200 identifies, separates and removes multiple types of glass, metals, plastics and paper in addition to corrugated containers and other recyclable items that are machine identified and removed from the solid waste.

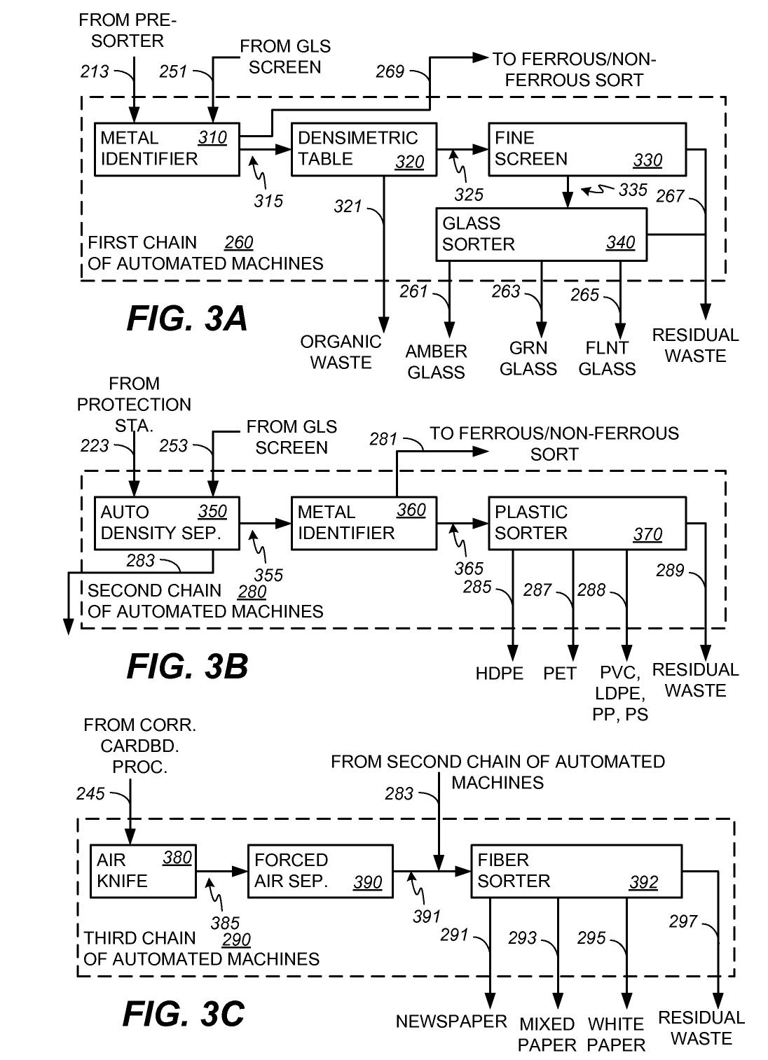

As shown in FIG. 2, recycling system 200 includes pre-sorter 210, protection station 220, bag opener 230, corrugated cardboard processor 240, glass screen 250, metal sorter 270, as well as first chain of automated machines 260, second chain of automated machines 280 and a third chain of automated machines 290. The arrangement and operation of each of the first chain of automated machines 260, second chain of automated machines 280 and third chain of automated machines 290 will be described in greater detail in association with the description of FIGS. 3A-3C.

Pre-sorter 210 is configured to distribute bulk solid waste received from collection pit 120 via input path 201 into multiple output paths in accordance with the size and type of the item. Most trash bags will be torn apart by the fingers in the pre-sorter 210. Unopened trash bags will travel on path 211 and will be intercepted at the protection station 220, where an operator forwards the unopened bags via path 221 to bag opener 230. Bag opener 230 uses automated equipment to destroy the integrity of the trash bag and drop the contents via path 231 back onto input path 201 to return the contents to pre-sorter 210. The removed trash bags are then collected for remediation in unrecycled solid waste remediator 130. Pre-sorter 210 forwards items larger than a first dimension, including items other than trash bags, via path 211 to protection station 220. In addition, pre-sorter 210 forwards all items smaller than a first dimension but larger than a second dimension via path 215 to glass screen 250. Pre-sorter 210 forwards items smaller than the second dimension via path 213 to first chain of automated machines 260.

Pre-sorter 210 can be arranged with multiple screens or decks of arranged fingers to filter appropriately sized items to the various output paths. A first screen or deck of arranged fingers are arranged with a separation distance of approximately the first dimension to convey items larger than the separation distance via path 217 to corrugated cardboard processor 240. A second screen or deck of arranged fingers are arranged with a separation distance of approximately the second dimension to convey items larger than the second dimension to glass screen 250 via path 215 while allowing items smaller than the second dimension to proceed via path 213 to the first chain of automated machines 260.

In one embodiment, the first dimension is approximately 8 inches and the second dimension is approximately ¾ of an inch. A vibrating deck of fingers transports the MSW to, and when the item is appropriately sized, through the first screen deck of arranged fingers. A vibrating deck of fingers transports solid waste items that pass the first deck through to the second deck.

Solid waste items that are much larger than the first dimension can bypass the pre-sorter 210. Organic items can be forwarded to a shredder and drier (not shown) before being forwarded to unrecycled solid waste remediator 130. Other relatively large solid waste items can be forwarded to one or more appropriately sized storage areas or bins such as recyclable store 302 to be held for further processing and/or transport to a recycler of the item. These other solid waste items may bypass recycling system as shown via path 203. In the illustrated embodiment, path 203 is shown terminating at a store 302 for recyclables. It should be understood that, depending on the item, further demolition, separation or other processing may be performed before the item or sub-items contained therein may be ready for recycling. It should be further understood that when solid waste contains non-recyclable items, such items may bypass recycling system 200 altogether. It should also be understood that non-recyclable organic material without substantial inorganic material, such as food waste and yard waste, may also bypass the recycling system 200 altogether.

Protection station 220 receives solid waste along path 211 from pre-sorter 210. The operator at protection station 220 separates and forwards recyclable, non-recyclable and hazardous items via defined paths in accordance with the waste item. Large items such as bicycle frames, lumber, parts of furniture, lawn chairs and corrugated boxes that are too big and other large items that might not have been removed from the collection pit 120 are carefully separated and removed from the recycling system 200, so that the subsequent automated equipment (e.g., corrugated cardboard processor 240) is protected from possible damage that might occur if one or more of the above-referenced items were to be introduced to the corrugated cardboard processor 240.

Any glass or plastic containers that may have been hidden in a plastic bag, under a sheet of cardboard, or some other waste item will be removed from the waste stream and placed on an appropriate path or path. For example, glass containers discovered in the waste stream are removed by the operator at protection station 220 and placed on path 227, which transports the glass containers to glass recyclable store 326. Plastic containers discovered in the waste stream are removed by the operator at protection station 220 and placed on path 229, which transports the plastic containers to recyclables store 302. It should be understood that glass and plastic containers transported to glass recyclable store 326 and recyclables store 302, respectively may be further processed to remove contaminants, labels, etc. Corrugated containers are allowed to continue to corrugated cardboard processor 240 via path 225. Other organic items larger than the second dimension that are not identified by an operator at protection station 220 as belonging to any of the categories of recyclable items (cloth, rubber, leather, etc.) will be forwarded via path 222 to unrecycled solid waste remediator 130. As described above, these items may be processed by a shredder and drier before being introduced to the unrecycled solid waste remediator 130.

Corrugated cardboard processor 240 receives the corrugated containers and separates and forwards them via one of three paths. In this regard, corrugated cardboard processor 240 forwards intact recyclables via path 241 to corrugated cardboard (CC) recyclable store 324. Fiber based items (e.g., paper) and other small items are separated for further processing via path 245. An air knife in proximity to path 245 separates the waste flow into material that will be recycled as mixed paper or containers that flow on path 297 to be converted into electricity by the unrecycled solid waste remediator 130 and the power generation system 140 (not shown).

Glass screen 250 receives the intermediate sized items from pre-sorter 210 via path 215 and forwards relatively small dense items to first chain of automated machines 260 via path 251. Glass screen 250 is also configured to forward larger (i.e., items up to the first dimension still within the intermediate range) items, such as items made from plastic, metal and paper to second chain of automated machines 280 via path 253. As further illustrated in FIG. 2, second chain of automated machines 280 also receives items smaller than the first dimension from protection station 220 via path 223.

As described above, the first chain of automated machines 260 receives the smallest sorted items from pre-sorter 210. One of the machines within first chain of automated machines 260 separates items consisting of metal from the solid waste stream and forwards these items along path 269 to metal sorter 270. Items smaller than ⅜″ are removed by a screen. One or more additional machines within first chain of automated machines 260 identify and separate pieces of amber colored glass, which are forwarded via path 261 to amber glass store 304. One or more additional machines within first chain of automated machines 260 identify and separate pieces of green colored glass which are forwarded via path 263 to green glass store 306. One or more additional machines within first chain of automated machines 260 identify and separate pieces of flint (i.e., clear) glass, which are forwarded via path 265 to flint glass store 308. Ceramics and other non-recyclable and/or unidentified items are forwarded along path 267 to unrecycled solid waste remediator 130.

The second chain of automated machines 280 receives mostly plastic items larger than the second dimension and smaller than the first dimension from glass screen 250. The second chain of automated machines 280 separates items consisting of metal from the solid waste stream and forwards these items along path 281 to metal sorter 270. One or more additional machines within the second chain of automated machines 280 identify and separate pieces or items made from HDPE (pigmented or natural), which are forwarded via path 285 to HDPE store 314. One or more additional machines within the second chain of automated machines 280 identify and separate pieces or items made from PET, which are forwarded via path 287 to PET store 316. One or more additional machines within second chain of automatic machines 280 identify and separate pieces or items made from polyvinyl chloride (PVC, labeled with recycle designator #3), low-density polyethylene (LDPE, labeled with recycle designator #4), polypropylene (PP, labeled with recycle designator #5), polystyrene (PS, labeled with recycle designator #6) and other plastics (labeled with recycle designator #7) to other plastic store 328. Non-recyclable and/or unidentified remaining items are forwarded along path 289 to non-recyclable solid waste remediator 130 or to an alternative store (not shown) for use in a secondary product.

Metal sorter 270 receives items believed to be made from metal via path 269 from the first chain of automated machines 260 and via path 281 from the second chain of automated machines 280. Metal sorter 270 identifies and separates items consisting of ferrous metals, which are forwarded via path 271 to ferrous item store 310. IN addition, metal sorter 270 identifies and separates items consisting of non-ferrous metals, which are forwarded via path 273 to non-ferrous item store 312.

The third chain of automated machines 290 receives paper items from second chain of automated machines 280 and corrugated cardboard via path 245 from corrugated cardboard processor 240. The third chain of automated machines 290 identifies and separates items consisting of fiber from the MSW stream. One or more machines within the third chain of automated machines 290 identify and separate newspaper, which is forwarded via path 291 to newspaper store 322. One or more additional machines within the third chain of automated machines 290 identify and separate mixed paper, which is forwarded via path 293 to mixed paper store 320. One or more additional machines within the third chain of automated machines 290 identify and separate white paper, which is forwarded via path 295 to white paper store 318.

FIGS. 3A-3C are schematic diagrams illustrating embodiments of the first chain of automated machines 260, the second chain of automated machines 280 and the third chain of automated machines 290 of FIG. 2. FIG. 3A illustrates an embodiment of the first chain of automated machines 260. The first chain of automated machines 260 includes a metal identifier 310, a densimetric or inert separator table 320, a fine screen 330 and a glass sorter 340. Metal identifier 310 receives solid waste from pre-sorter 210 via path 213 and from glass screen 250 via path 251. Metal identifier 310 identifies and separates items consisting of metal from glass and other materials. A first output 269 of metal identifier 310 forwards items consisting of metal to a ferrous/non-ferrous metal sorter. A second output 315 of metal identifier 310 forwards non-metal items to densimetric table 320. Densimetric table 320 identifies and separates organic waste from glass, small batteries and other relatively dense items in the MSW. A first output 321 of densimetric table 320 forwards organic waste to unrecycled solid waste remediator 130. A second output 325 forwards glass and the other relatively dense items to fine screen 330 past a cross belt magnet (not shown) that removes any remaining magnetic waste. Fine screen 330 separates and forwards waste items smaller than a third dimension via output path 267. Glass and other ceramic materials captured by fine screen 330 are forwarded via path 335 to glass sorter 340. Glass sorter 340 identifies and separates amber, green and clear glass pieces. Amber colored glass pieces are forwarded along path 261. Green colored glass pieces are forwarded along path 263. Flint or clear glass pieces are forwarded along path 265. Ceramic or other residual material is coupled with the waste from fine screen 330 along path 267.

FIG. 3B illustrates an embodiment of the second chain of automated machines 280. The second chain of automated machines 280 includes an automatic density separator 350, a metal identifier 360, and a plastic sorter 370. Automatic density separator 350 receives solid waste from protection station 220 via path 223 and from glass screen 250 via path 253. Automatic density separator 350 identifies and separates items consisting of paper and plastic film from other items in the MSW. A first output 283 forwards items consisting of paper to the third chain of automated machines 290. A second output 355 forwards items consisting of metal and plastic to metal identifier 360. Metal identifier 360 identifies metal items from non-metal items. A first output 281 forwards items consisting of metal to a ferrous/non-ferrous metal sorter. A second output 365 forwards non-metal items to plastic sorter 370. Plastic sorter 370 identifies and separates different types of recyclable plastic items from other non-metal items in the solid waste. A first output 285 of plastic sorter 370 forwards items consisting of HDPE to HDPE store 314 (not shown). A second output 287 of plastic sorter 370 forwards items consisting of PET to store 316 (not shown). A third output of 288 of plastic sorter 370 forwards items consisting of one or more of PVC, LDPE, PP, PS and other plastics to other plastic store 328 (not shown). It should be understood that plastic sorter 370 may be arranged with more or less outputs. For example, items consisting of HDPE may be further sorted based on whether the item is pigmented or natural. This further sorting will result in items being stored and/or bundled in corresponding stores for pigmented HDPE and natural HDPE. By way of further example, items consisting of PVC (recycle designator #3), LDPE (recycle designator (#4), PP (recycle designator #5), PS (recycle designator #6) and other plastics (recycle designator #7), all of which are generally not recycled, may be temporarily stored in other plastic store 328 (not shown). When recycle markets develop for goods consisting these plastics, plastic sorter 370 may be configured with additional outputs. These additional outputs will correspond to a specified type of plastic. A fourth output 289 forwards organic and other non-metal residual waste to unrecycled solid waste remediator 130.

FIG. 3C illustrates an embodiment of the third chain of automated machines 290. The third chain of automated machines 290 includes an air knife 380, a forced or vacuum air separator 390, and a paper sorter 392. Air knife 380, sometimes called a wind sifter, separates heavy material from lighter material by blowing air from under the end of a path. Lighter material will deflect upwards into a chute while the heavier materials will be relatively unaffected and will fall into a lower chute. The lighter items removed by the air knife 380 are forwarded along path 385 to air separator 390. Forced air separator 390 separates items in the MSW that may be stuck to one another. The separated items are forwarded along output path 391 where they are mixed with fiber and containers received from second chain of automated machines 280 before being introduced to fiber sorter 392. Fiber sorter 392 identifies and separates different types of recyclable fiber from one another and from unidentifiable fiber in the MSW. A first output of fiber sorter 392 includes newspaper, which is forwarded along path 291 to newspaper store 322 (not shown). A second output of fiber sorter 392 includes mixed paper, which is forwarded along path 293 to mixed paper store 320 (not shown). A third output of fiber sorter 392 includes white paper, which is forwarded along path 295 to white paper store 318 (not shown).

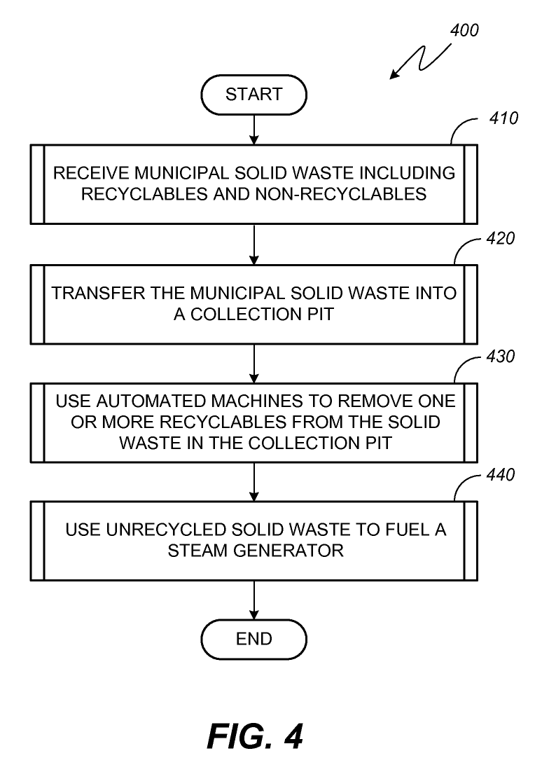

FIG. 4 is a flow diagram illustrating an embodiment of a method 400 for processing municipal solid waste. Method 400 begins with block 410 where municipal solid waste is received. The received solid waste may include recyclable items and non-recyclable items. In block 420, the received solid waste is transferred into a collection pit. Thereafter, as indicated in block 430, automated machines are used to remove one or more recyclables from the solid waste in the collection pit. In block 440, the remaining solid waste is used to fuel a steam generator.

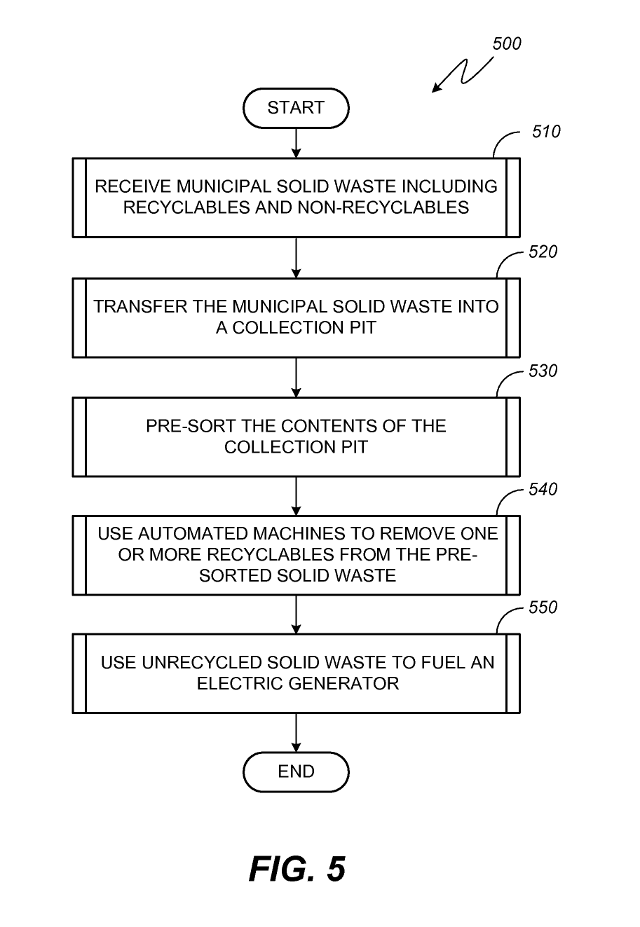

FIG. 5 is a flow diagram illustrating an alternative embodiment of a method 500 for processing municipal solid waste. Method 500 begins with block 510 where municipal solid waste is received. The received solid waste may include recyclable items and non-recyclable items. In block 520, the received solid waste is transferred into a collection pit. As indicated in block 530, the contents of the collection pit are pre-sorted. Thereafter, as indicated in block 540, automated machines are used to remove one or more recyclables from the pre-sorted solid waste. In block 550, the remaining unrecycled solid waste is used to fuel an electric generator.

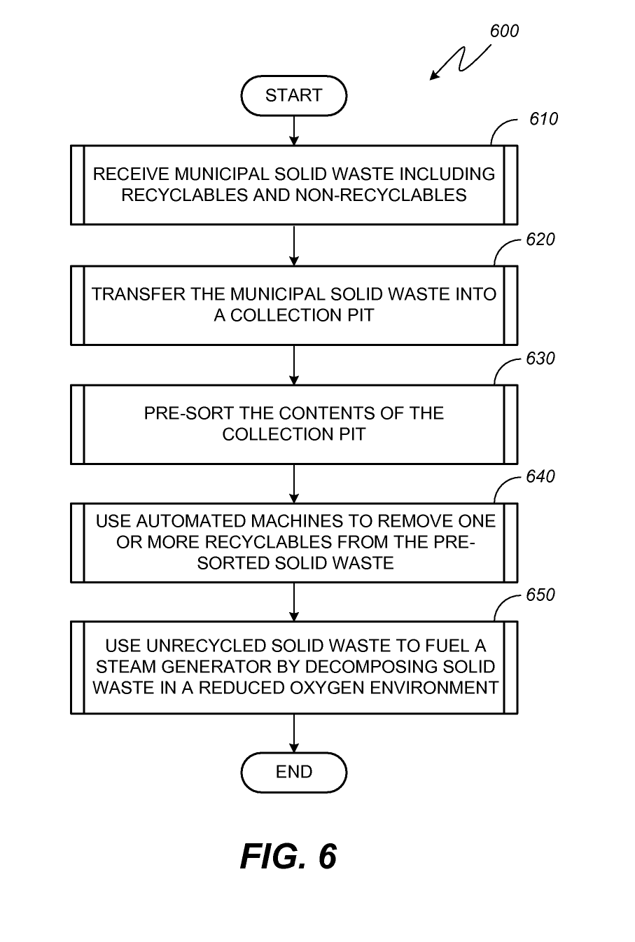

FIG. 6 is a flow diagram illustrating another alternative embodiment of a method 600 for processing municipal solid waste. Method 600 begins with block 610 where municipal solid waste is received. The received solid waste may include recyclable items and non-recyclable items. In block 620, the received solid waste is transferred into a collection pit. As indicated in block 630, the contents of the collection pit are pre-sorted. Thereafter, as indicated in block 640, automated machines are used to remove one or more recyclables from the pre-sorted solid waste. In block 650, the remaining unrecycled solid waste is used to fuel a steam generator by decomposing the solid waste in a reduced oxygen (i.e., preferably oxygen starved) environment.

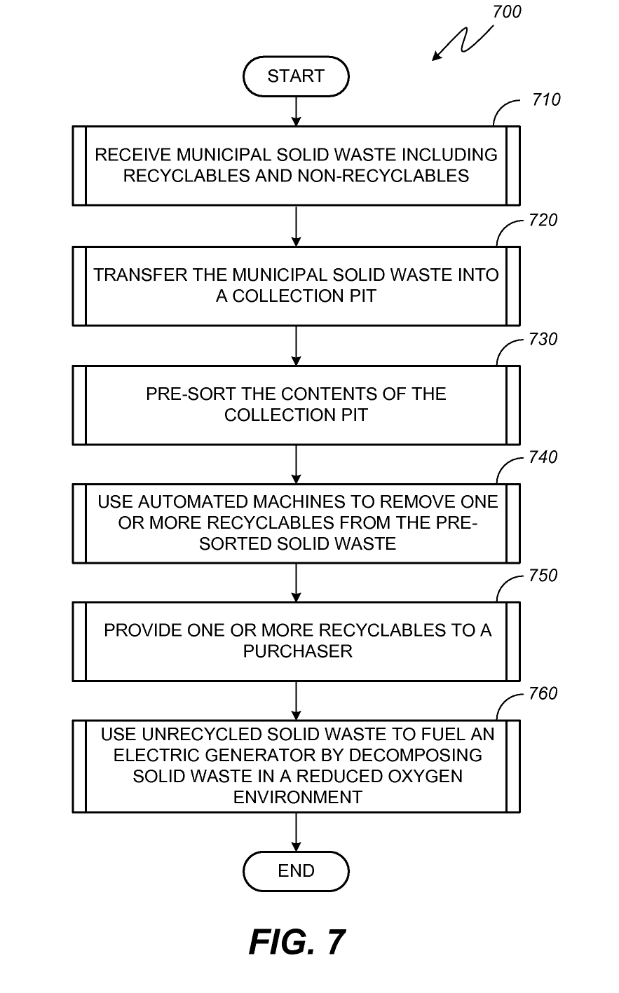

FIG. 7 is a flow diagram illustrating a fourth alternative embodiment of a method 700 for processing municipal solid waste. Method 700 begins with block 710 where municipal solid waste is received. The received solid waste may include recyclable items and non-recyclable items. In block 720, the received solid waste is transferred into a collection pit. As indicated in block 730, the contents of the collection pit are pre-sorted. Thereafter, as indicated in block 740, automated machines are used to remove one or more recyclables from the pre-sorted solid waste. In block 750, one or more recyclables are provided to a purchaser of such items. As described above, as a part of this process, the one or more recyclables may be further rinsed, washed, arranged, bundled or otherwise packaged to make the one or more recyclables suitable for recyclable markets. In block 760, the remaining unrecycled solid waste is used to fuel an electric generator by decomposing the solid waste in a reduced oxygen (i.e., preferably oxygen starved) environment.

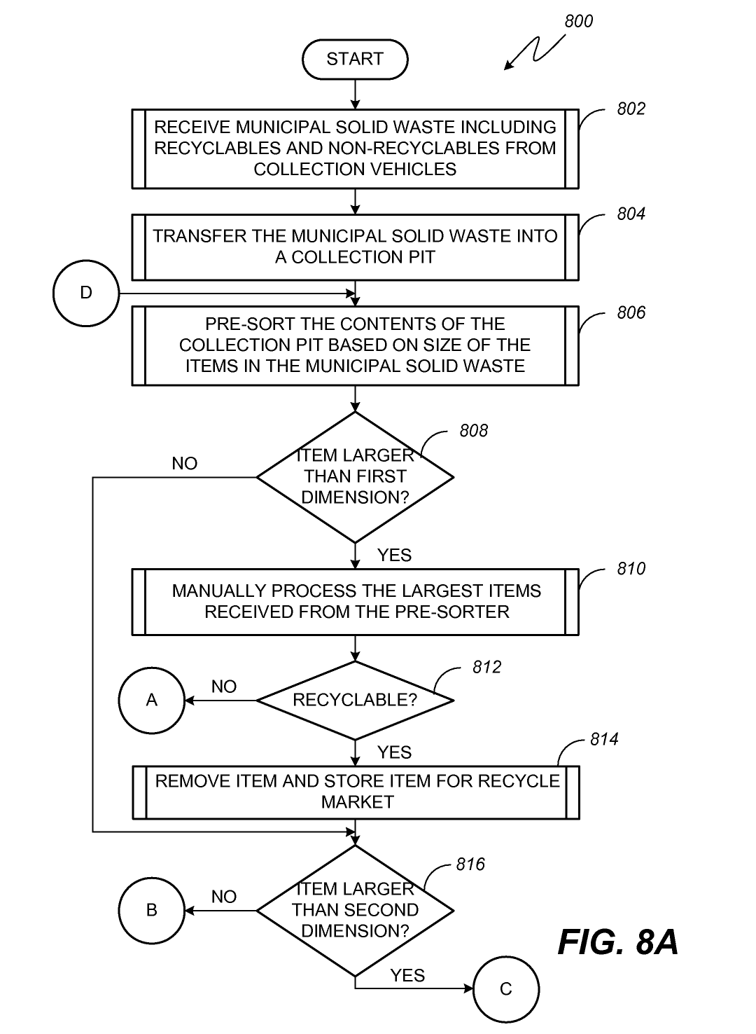

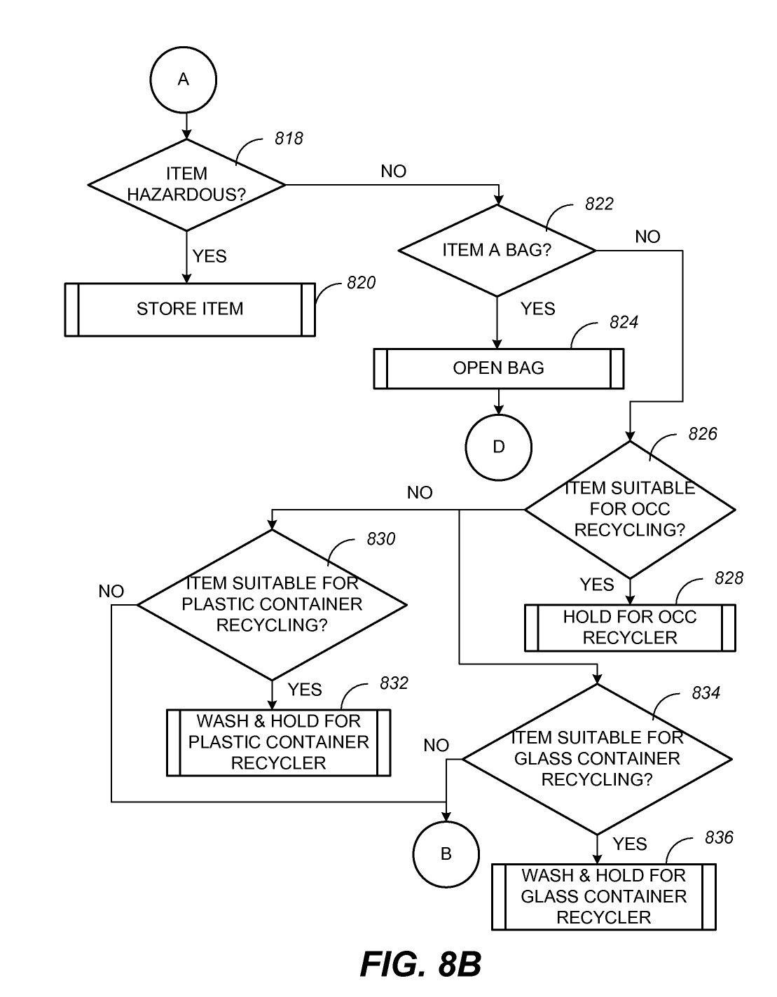

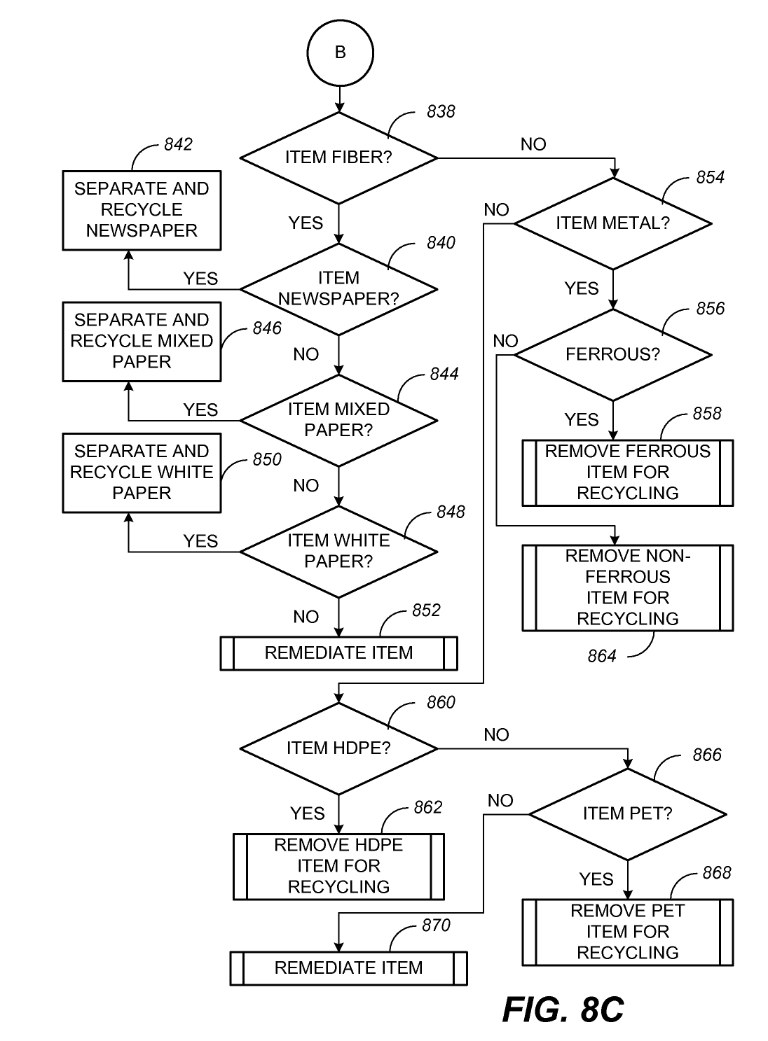

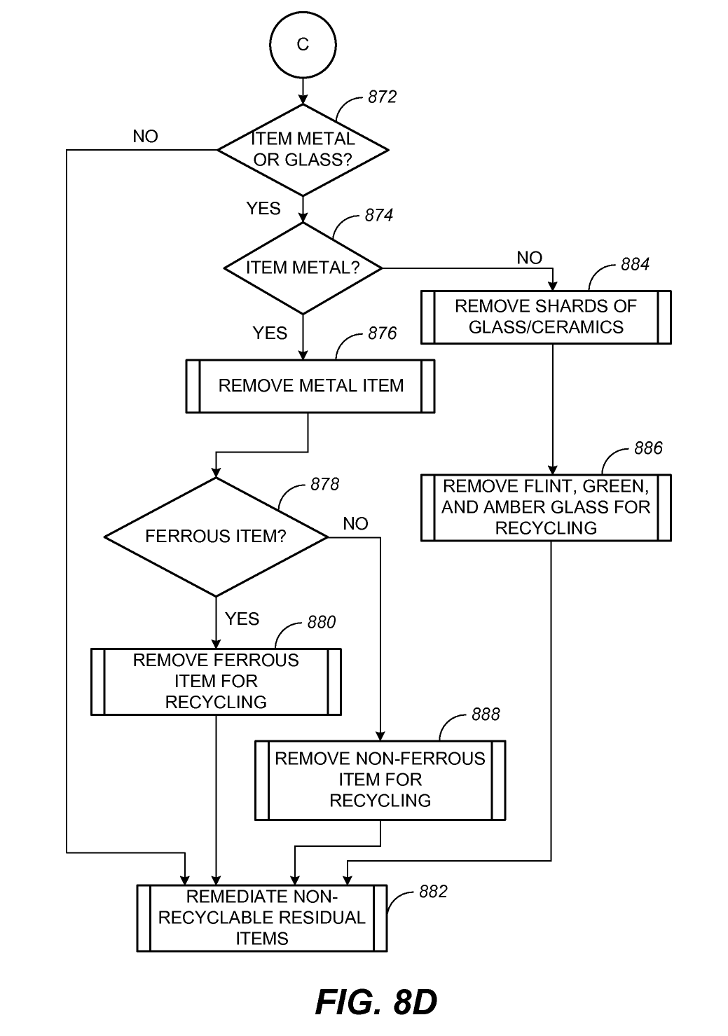

FIGS. 8A-8D are flow diagrams illustrating another alternative embodiment of a method 800 for processing municipal solid waste. The flow diagram of FIG. 8 shows the functionality and operation of a possible implementation via a protection station and automated machinery arranged to identify, sort and store multiple types of recyclable items. Method 800 begins with block 802 where municipal solid waste is received. The received solid waste may include recyclable items and non-recyclable items from conventional waste collection vehicles. In block 804, the received solid waste is transferred into a collection pit. It should be understood that the collection pit may receive solid waste from multiple collection vehicles via multiple scales and receiving slots connected to the collection pit. As indicated in block 806, the contents of the collection pit are pre-sorted based on size. As shown by decision block 808, a determination is made whether an item is larger than a first dimension. As described above, this first dimension in one embodiment is approximately 8 inches although alternative first dimensions could be used. When it is determined that an item is larger than the first dimension, as indicated by the flow control arrow exiting decision block 808 labeled “YES,” the item is processed manually as shown in block 810.

Any closed trash bags or other containers that may contain recyclables and/or items that should not be remediated are handled by an operator at the protection station. Unopened trash bags are forwarded to a bag opener that separates the contents from the bag. As described above, the released contents are returned to the pre-sorter. Closed containers in the MSW are opened by the operator at the protection station. The operator releases and forwards the contents of containers in accordance with what the operator finds in the containers. The opened container is forwarded to an appropriate chain of automated machines in accordance with the nature of the container. In appropriate instances, the container may be cleaned or otherwise processed to remove labels or residual matter from the container.

In decision block 812, a determination is made whether the item is recyclable. When the item is not recyclable, as shown by the flow control arrow exiting decision block 812 labeled, “NO,” processing proceeds with decision block 818 via connector A (FIG. 8B). Otherwise, when the item is recyclable and oversized as indicated by the flow control arrow labeled “YES,” exiting decision block 812, the item is removed and stored for sale in an appropriate recycle market, as shown in block 814. It should be understood that depending on the item and the requirements of the market, the recyclable item may be further processed, counted, weighed, packaged, etc. When this is the case, it is desired that as much of the additional processing is performed via automated machines.

When an item is not larger than the first dimension as shown by the flow control arrow labeled “NO,” exiting decision block 808, processing continues with decision block 816. In decision block 816, a determination is made whether a pre-sorted item is larger than a second dimension (i.e., the smallest dimension used to distinguish or sort solid waste items). When the pre-sorted item is larger than the second dimension, as indicated by the flow control arrow labeled “YES,” exiting decision block 816, processing proceeds with decision block 872 via connector C (FIG. 8D). When the pre-sorted item is not larger than the second dimension, as indicated by the flow control arrow labeled “NO,” exiting decision block 816, processing proceeds with decision block 838 via connector B (FIG. 8C). As described above, in one embodiment, the second dimension is approximately ¾ of an inch. However, alternative dimensions could be used to identify or classify relatively small items in the solid waste.

FIG. 8B illustrates that portion of method 800 between connector A and connector B. Specifically, in decision block 818 a decision is made whether the pre-sorted item is hazardous. When it is the case that the pre-sorted item is hazardous, as indicated by the flow control arrow labeled “YES,” exiting decision block 818, the item is stored for later recovery or special handling as indicated in block 820. Otherwise, when it is determined that the pre-sorted item is non-hazardous, as indicated by the flow control arrow labeled “NO,” exiting decision block 818 a determination is made whether the pre-sorted item is a filled bag as shown in decision block 822. When the pre-sorted item is a filled bag, as shown by the flow control arrow labeled “YES,” exiting decision block 822, the bag is forwarded to a bag opener where the bag is opened as indicated in block 824 and removed releasing the items within the bag. The removed items are returned to repeat the functions in blocks 806 to block 824 via connector D (FIG. 8A). Otherwise, when the item is not a bag, as shown by the flow control arrow exiting decision block 822 labeled “NO,” processing continues with decision block 826 where a determination is made whether the item is an oversized corrugated container. When it is determined that the pre-sorted item is an oversized corrugated container, as indicated by the flow control arrow labeled “YES,” exiting decision block 826, the item is removed to store for an appropriate recycler or transporter as indicated in block 828. Alternatively, the large corrugated containers can be forwarded to unrecycled solid waste remediator 130. Otherwise, when it is determined that the pre-sorted item is not suitable for corrugated container recycling, as indicated by the flow control arrow labeled “NO,” exiting decision block 826, processing continues with decision block 830 and decision block 834.

In decision block 830, a determination is made whether the item is suitable for plastic container recycling. When it is determined that the pre-sorted item is suitable for plastic container recycling, as indicated by the flow control arrow labeled “YES,” exiting decision block 830, the container is removed from the MSW to store for an appropriate recycler or transporter as indicated in block 832. As described above, the plastic container may be stored with recyclables sharing a common plastic recycle designator number. In addition, containers made from HDPE may be further separated based on whether the HDPE is natural or pigmented.

In decision block 834, a determination is made whether the item is suitable for glass container recycling. When it is determined that the pre-sorted item is suitable for glass container recycling, as indicated by the flow control arrow labeled “YES,” exiting decision block 834, the glass container is removed from the MSW to store for an appropriate recycler or transporter as indicated in block 836. As described above, the glass container may be stored with recycle glass containers made from the same type of glass. Prior to storing, the glass containers may be washed or otherwise processed to remove contaminants and/or any remaining labels. Otherwise, when it is determined that the pre-sorted item is not suitable for plastic or glass container recycling as indicated by the flow control arrows labeled, “NO,” exiting decision block 830 and decision block 834, processing continues via connector B with decision block 838 (FIG. 8C).

As illustrated in FIG. 8C method 800 continues with decision block 838 where a determination is made whether an item is fiber or made from a material other than fiber. When it is the case that the item is fiber, a series of additional determinations are made as indicated by decision blocks 840, 844 and 848 in an effort to group the item with a fiber type. In decision block 840 a determination is made whether the item is newspaper. When the item is newspaper as indicated by the flow control arrow labeled “YES,” exiting decision block 840, the newspaper is separated and stored for recycling as shown in block 842. Otherwise, when the fiber item is not newspaper as indicated by the flow control arrow labeled “NO,” exiting decision block 840, processing continues with decision block 844 where it is determined if the item is mixed paper. When it is the case that the fiber item is mixed paper, as indicated by the flow control arrow labeled “YES,” exiting decision block 844, the mixed paper is separated and stored for recycling as shown in block 846. Otherwise, when the fiber item is not mixed paper, as indicated by the flow control arrow labeled “NO,” exiting decision block 844, processing continues with decision block 848, where a determination is made if the fiber item is white paper. When it is the case that the fiber item is white paper, as indicated by the flow control arrow labeled “YES,” exiting decision block 848, the white paper is separated and stored for recycling as shown in block 850. Otherwise, when the fiber item is not white paper, as indicated by the flow control arrow labeled “NO,” exiting decision block 848, processing continues by remediating the fiber item as shown in block 852. Otherwise, when the item is not made of fiber, as indicated by the flow control arrow labeled “NO,” exiting decision block 838, processing continues with decision block 854.

In decision block 854, a determination is made whether the item is made from metal. When the item is metal, as indicated by the flow control arrow labeled “YES,” exiting decision block 854, a determination is made as shown in decision block 856 whether the metal is a ferrous metal. When the metal item is made from a ferrous metal, as indicated by the flow control arrow labeled “YES,” exiting decision block 856, the ferrous metal item is removed for recycling as indicated in block 858. Otherwise, when the metal item is made from a non-ferrous metal, as indicated by the flow control arrow labeled “NO,” exiting decision block 856, the non-ferrous item is removed for recycling as indicated in block 864. Otherwise, when the item is not made of metal, as indicated by the flow control arrow labeled “NO,” exiting decision block 854, processing continues with decision block 860.

In decision block 860, a determination is made whether the item is made from high-density polyethylene (HDPE). When the item is made from HDPE as indicated by the flow control arrow labeled “YES” exiting decision block 860, the item is removed and stored for recycling as indicated in block 862. As described above, HDPE items may be further sorted and baled or otherwise prepared for transport to a recycler of HDPE items. As also described above, the HDPE items may be sorted in accordance to whether the item is made from natural HDPE or pigmented HDPE. Otherwise, when the item is not made from HDPE as indicated by the flow control arrow labeled “NO,” exiting decision block 860, processing continues with decision block 866, where a determination is made whether the item is made from polyethylene terephthalate (PET, the acronym used by the chemical industry or PETE, the acronym used by U.S. based manufacturers of plastic bottles). When the item is made from PET, as indicated by the flow control arrow labeled “YES,” exiting decision block 866, the PET item is removed and held for recycling, as indicated in block 868. When the item is not made from PET, as indicated by the flow control arrow labeled, “NO,” exiting decision block 866, processing continues with block 870 where the item is remediated.

It should be understood that in alternative processing methods (not shown) other items made from plastics associated with one or more recycle designator numbers 3 through 7 (PVC, LDPE, PP, PS and other plastics, respectively) are identified, separated and baled for collection by one or more recyclers or transporters.

As described above, remaining plastics plus any unrecycled material is shred, dried and remediated. Fuels produced by the unrecycled solid waste remediator 130 can be used to generate steam and/or to drive a turbine generator to produce electricity. For simplicity of illustration, pre-processing, including shredding and drying of organic waste and remediation processing steps are not shown in the flow diagram of method 800.

The flow diagram illustrated in FIG. 8D is a continuation of the method 800 from decision block 816 via connector B (FIG. 8A). Method 800 continues with the processing of relatively smaller items. As indicated in decision block 872, a determination is made whether an item is made from metal or glass. As described above, this determination can be made using a machine that sorts items based on density as items made from metal or glass will be denser than similarly sized items made from fiber or plastics. When the item is metal or glass as indicated by the flow control arrow labeled “YES,” exiting decision block 872, processing continues with decision block 874 where a determination is made whether the item is metal. Otherwise, when it is determined that the item is not metal or glass as indicated by the flow control arrow labeled “NO,” exiting decision block 872, the item is remediated as shown in block 882.

When the item is metal as indicated by the flow control arrow labeled “YES,” exiting decision block 874, the metal item is removed or otherwise separated from the solid waste as shown in block 876. Thereafter, as indicated in decision block 878, a determination is made whether the metal item is made from a ferrous metal. When the metal item is made from a ferrous metal, as indicated by the flow control arrow labeled “YES,” exiting decision block 878, the ferrous item is removed for recycling as indicated in block 880. Otherwise, when the metal item is made from a non-ferrous metal, as indicated by the flow control arrow labeled “NO,” exiting decision block 878, the non-ferrous metal item is removed for recycling as shown in block 888.

When a non-metal (i.e., glass) item is identified as indicated by the flow control arrow labeled “NO,” exiting decision block 874, pieces of broken glass or ceramic material are removed from the material flow as indicated by block 884. Thereafter, as indicated in block 886, flint, green and amber glass pieces are identified and separated for recycling. As indicated in block 882 and by the various flow control arrows entering block 882 any small organic, ceramic or other residual items (i.e., non-recyclable or unrecycled) are remediated.

While the flow diagram of FIGS. 8A-8D show a specific sequence of execution, it will be appreciated that the functions associated with two or more blocks in the illustrated diagrams that are shown occurring in succession can be executed concurrently (and preferably are performed concurrently to provide one or more fuel sources to supply power generation system 140), with partial concurrence, or in an alternative sequence. For example, it is possible for pre-sorted items to be simultaneously and continuously processed by each of the above described first, second and third chains of automated machines to identify sort and or remove various recyclable items from each of the solid waste streams with residual solid waste and organic waste being forwarded to the unrecycled solid waste remediator 130. All such variations are within the scope of the present systems and methods for processing municipal solid waste.

The foregoing description has been presented for purposes of illustration and description. It is not intended to be exhaustive or to limit the scope of the claims to the precise forms disclosed. Modifications or variations are possible in light of the above teachings. The embodiments discussed, however, were chosen and described to enable one of ordinary skill to utilize various embodiments of the systems and methods for processing solid waste. All such modifications and variations are within the scope of the appended claims when interpreted in accordance with the breadth to which they are fairly and legally entitled.

What is claimed is:

1. A method for processing MSW, comprising:
receiving MSW, the MSW including organic, inorganic, recyclables and non-recyclables;
transferring the MSW into a collection pit;
conveying the MSW from the collection pit to a recycling system;
using automated means in the recycling system for removing one or more recyclables; and
using unrecycled organic material from the recycling system to fuel a power system.

2. The method of claim 1, wherein the steps of conveying the MSW, using automated means in the recycling system for removing one or more recyclables and using unrecycled organic material are substantially concurrent and continuous.

3. The method of claim 1, further comprising:
sorting the MSW.

4. The method of claim 3, wherein sorting comprises manually removing corrugated containers and identified items unsuitable for processing via a corrugated container machine.

5. The method of claim 3, wherein sorting comprises using a multiple output sorter that directs MSW to an output based on the size of an individual item.

6. The method of claim 5, wherein sorting further comprises using a bag opener to open bags that didn't open in the pre-sorter.

7. The method of claim 6, wherein sorting further comprises removing intact glass items.

8. The method of claim 7, further comprising removing paper and printed labels, washing and selling the removed glass items.

9. The method of claim 3, wherein sorting further comprises forwarding individual items having a dimension larger than a first predetermined dimension for subsequent processing.

10. The method of claim 3, wherein sorting further comprises forwarding individual items having a dimension larger than a second predetermined dimension for processing that separates and removes multiple types of one or more of paper, metal and plastic from the remaining MSW.

11. The method of claim 10, wherein processing that separates and removes multiple types of one or more of paper, metal and plastic from the remaining MSW is responsive to density of an item.

12. The method of claim 3, wherein sorting further comprises forwarding individual items having a dimension smaller than a second predetermined dimension for processing that separates and removes multiple types of one or more of metal and glass from the remaining MSW.

13. The method of claim 12, wherein sorting further comprises separating and removing ferrous from non-ferrous metal.

14. The method of claim 12, wherein sorting further comprises separating and removing one or more of amber, green and flint glass.

15. The method of claim 1, wherein the step of using the unrecycled organic material from the recycling system to fuel a power system further comprises decomposing the unrecycled organic portion of the MSW in a reduced oxygen environment.

16. The method of claim 15, further comprising applying a source of heat under a vacuum.

17. The method of claim 15, further comprising collecting byproducts in the form of fuels.

18. The method of claim 1, further comprising providing one or more recyclables to a purchaser.

19. The method of claim 1, further comprising handling one or more recyclables in a manner that maintains marketable integrity of the recyclables.

20. A system for processing municipal solid waste (MSW), comprising:
a collection pit coupled to a pre-sorter, the pre-sorter configured to forward the MSW via multiple outputs;
a protection station arranged to receive the MSW from a first pre-sorter output, the first pre-sorter output including items having a dimension larger than a first predetermined dimension;
a corrugated cardboard processor coupled to an output of the protection station, the corrugated cardboard processor arranged to remove recyclable corrugated cardboard from the MSW;
an assembly configured to receive MSW from a second pre-sorter output, the second pre-sorter output including items having a dimension smaller than the first predetermined dimension and larger than a second predetermined dimension;
a first chain of automated machines configured to receive MSW from a third pre-sorter output, the third pre-sorter output including items having a dimension smaller than the second predetermined dimension, wherein the first chain of automated machines are configured to remove items consisting of metals and glass from the solid waste;
a second chain of automated machines configured to receive MSW from the protection station and items from the assembly, the second chain of automated machines configured to separate and remove items consisting of paper, metal and plastic from the MSW; and
a third chain of automated machines configured to receive non-bulk recyclable corrugated cardboard from the corrugated cardboard processor and paper items from the second chain of automated machines.

21. The system of claim 20, further comprising a remediator configured to receive unrecycled MSW from each of the first, second and third chains of automated machines, the remediator configured to convert the unrecycled MSW into one or more fuels.

22. The system of claim 21, further comprising a power generation system configured to convert the one or more fuels into electricity.

23. The system of claim 22, wherein the one or more fuels are used to convert water into steam.

24. The system of claim 23, wherein a portion of the steam is sold.
